(19) United States
(12) Patent Application Publication
(10) Pub. No.: US 2019/0347333 A1
(43) Pub. Date: Nov. 14, 2019

(54) SYSTEMS AND METHODS FOR LOG FILE RANKING AND REPLAY

(71) Applicant: salesforce.com, inc., San Francisco, CA (US)

(72) Inventors: Sanjeev SAHU, San Jose, CA (US); Sandeep PARWAL, San Francisco, CA (US); Lishu WANG, Fremont, CA (US); Ke LU, Foster City, CA (US); Congrui XU, San Mateo, CA (US); Yushu YAO, Richmond, CA (US)

(21) Appl. No.: 15/973,920

(22) Filed: May 8, 2018

(51) Int. Cl. G06F 17/30

(52) U.S. Cl. CPC G06F 17/3053; G06F 17/30106; G06F 17/30091

(57) ABSTRACT

Systems and methods for improving log file completeness are described. A high completeness value equal to or greater than a target completeness value is accomplished by re-shipping or replaying a subset of the missing log records from their respective hosts. Hosts (and respective log files) are ranked in order of completeness impact, allowing a determination of which minimum combination of hosts should be selected for replay to achieve the target completeness value. Intermediate log record counts are used to determine gaps in the log file. For example, record the number of log file records in five minute intervals to determine which sections of the log files need to be replayed, thereby avoiding the replay of entire log files, which may be prohibitively large.

### TECHNICAL FIELD

Embodiments of the subject matter described herein relate generally to on-demand software systems. More particularly, embodiments of the subject matter relate to log file fidelity in such on-demand software systems.

### BACKGROUND

It is often advantageous, in on-demand software systems, to transfer log file records from an application host (e.g., a data center application) to a destination (e.g., a “secure” zone) for future reference and analysis. However, due to the massive size of such log files—some of which may accumulate millions of log file records per day—it can be intractable to maintain complete copies of such log files in real time as they are generated. As a result, the fidelity or “completeness” of log file records stored in the secure zone can be unsatisfactory.

Accordingly, it is desirable to provide improved systems and methods for improving the transfer and storage of large log file records associated with application hosts. Furthermore, other desirable features and characteristics will become apparent from the subsequent detailed description and the appended claims, taken in conjunction with the accompanying drawings and the foregoing technical field and background.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a conceptual block diagram showing an exemplary embodiment of a system for transferring log files;

FIG. 2 depicts, in tabular form, various replay candidates in accordance with one embodiment;

FIG. 3 illustrates an exemplary log file including a plurality of log records;

FIG. 4 illustrates the use of intermediate log record counts in accordance with one embodiment;

FIG. 5 is a block diagram illustrating a method in accordance with one embodiment; and

FIG. 6 is a block diagram of an exemplary database system suitable for use with the system of FIG. 1 in accordance with one or more embodiments.

### DETAILED DESCRIPTION

Systems and methods for improving log file fidelity are described. In general, a very high log file completeness value equal to or greater than a selected target completeness value (e.g., 99.9% or better) is accomplished by re-shipping or replaying at least some of the missing log records from their respective hosts. To accomplish this efficiently, the hosts (and respective log files) for a particular time interval (e.g., a 24-hour period) are ranked in order of completeness impact, that is, the worst offenders rise to the top of the list, allowing a determination of which minimum combination of hosts should be selected for replay to achieve the target completeness value. In some embodiments, intermediate log record counts are used to determine gaps in the log file. For example, a system can record the number of log file records in five minute intervals to determine which sections of the log files need to be replayed, thereby avoiding the replay of entire log files, which may be prohibitively large.

A method of log file remediation in accordance with certain embodiments includes generating, at one or more host servers, a first set of log files, each including a plurality of log file records, and storing, at a destination server, a second set of log files, each substantially corresponding to a respective one of the first set of log files. The method further includes ranking, with a processor, the second set of log files based on a completeness impact determined with respect to each of the second set of log files, the completeness impact computed based on a difference in record counts between the first and second sets of log files. A set of replay candidate log files are determined based on the ranking, and a subset of the replay candidate log files are replayed to achieve a target completeness value.

A database system in accordance with certain embodiments includes a processor in communication with a memory element that has computer-executable instructions stored thereon and configurable to be executed by the processor to cause the database system to generate, at one or more host servers, a first set of log files, each including a plurality of log file records; store, at a destination server, a second set of log files, each substantially corresponding to a respective one of the first set of log files; rank the second set of log files based on a completeness impact determined with respect to each of the second set of log files, the completeness impact computed based on a difference in record counts between the first and second sets of log files; determine a set of replay candidate log files based on the ranking; and replay a subset of the replay candidate log files that achieves a target completeness value.

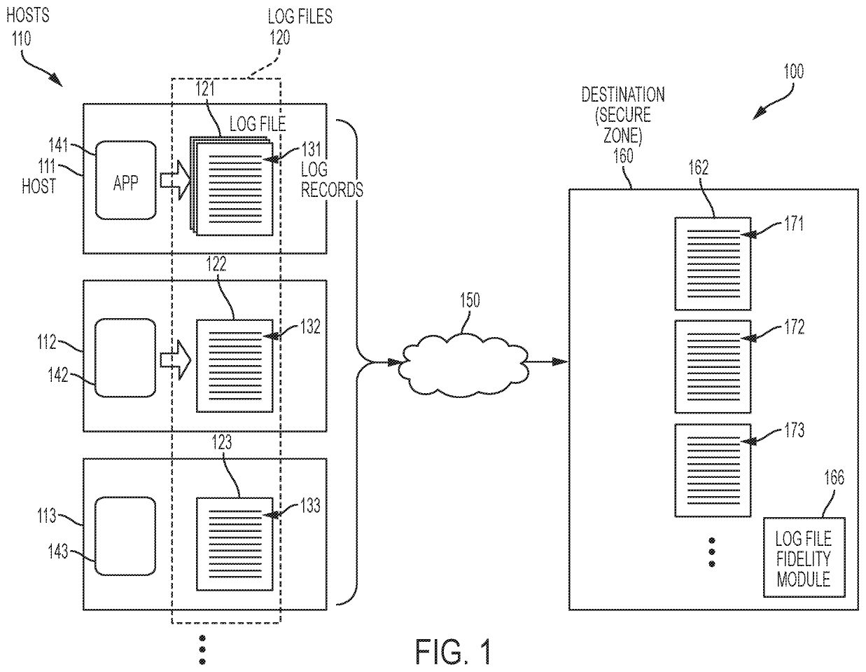

FIG. 1 is a conceptual block diagram illustrating an exemplary computer-based system 100 useful in describing various embodiments. In general, system 100 includes a plurality of application hosts or simply “hosts” 110 (e.g., hosts 111, 112, 113, etc.). Each host 110 includes at least one application (or “app”), such as apps 141, 142, 143, configured to generate one or more respective log files 120 (e.g., 121, 122, and 123, respectively). As is known in the art, log files 120 may include an assortment of indicia documenting the operation of their respective apps 141, 142, 143, such as various events, errors, warnings, and the like.

Hosts 110 may be implemented with and/or incorporate conventional database server hardware and software, such as database management system or other equivalent software capable performing the methods described herein. Applications 141, 142, etc. may be implemented as on-demand virtual applications generated by an application platform as known in the art. Hosts 110 and a destination 160 may be implemented using one or more actual and/or virtual computing systems that collectively provide a dynamic type of app platform for generating apps 141-143. For example, hosts 110 may be implemented using a cluster of actual and/or virtual servers operating in conjunction with each other, typically in association with conventional network communications, cluster management, load balancing and other features as appropriate. Each will typically incorporate processing hardware such as a processor, memory, input/output components, and the like. Such processors may be implemented using any suitable processing system, such as one or more processors, controllers, microprocessors, microcontrollers, processing cores and/or other computing resources spread across any number of distributed or integrated systems, including any number of “cloud-based” or other virtual systems. Hosts 110 may include any convenient non-transitory short or long term storage or other computer-readable media capable of storing programming instructions for execution on a processor, including for example a random access memory (RAM), a read only memory (ROM), a flash memory, magnetic or optical mass storage, and/or the like. The computer-executable programming instructions, when read and executed, cause the hosts 110 to create, generate, or otherwise facilitate the apps 141-143 and perform one or more additional tasks, operations, functions, and/or processes described herein. Each app 141-143 may be generated at run-time (as an “on-demand” app) using any convenient platform. In accordance with one non-limiting example, the hosts 110 are implemented in the form of an on-demand multi-tenant customer relationship management (CRM) system that can support any number of authenticated users for a plurality of tenants.

The content of the log files 120 will generally be determined by the app itself, but in many non-limiting examples a log file 120 comprises a list or sequence of log records (131, 132, 133) including a text string terminated by a delimiter, such as a new line character. In many embodiments, log records 131, 132, 133 include time stamps or other information indicating when the respective event, error, etc. occurred.

As mentioned briefly above, it is often advantageous to transfer log files 120 to a destination (e.g., a secure zone) 160 via a network 150. This is illustrated in FIG. 1 as a set of log files 162 stored within destination 160. More particularly, in this example, it is presumed that the log files 162 stored within destination 160, in a best case scenario, should correspond exactly to the log files 120 generated by the hosts 110. However, as also described briefly above, it is often the case that a number of log records (in this example, log records 132) are not successfully transferred from the host 112 to the destination 160 during some predetermined time period (e.g., 24 hours). That is, the log record count of log records 171 may be less than the log record count of log records 132.

Although not a requirement of the described system and methodology, in certain embodiments each host generates one log file per day, which is intended for delivery to the destination 160. Each log file (or a group of log files for a host) may include a respective statistics file, metadata, or any suitably formatted data object that characterizes and/or describes that particular log file (or group of log files). For example, a log file may have a corresponding statistics file that includes a count of the number of log records included in the log file. The statistics file is also intended for delivery to the destination 160. The statistics file allows the destination 160 to check the content of a received log file against the expected content (by counting the number of log records actually received and comparing the count to the expected number as indicted by the received statistics file).

In accordance with one example, the log transfer completeness (or simply “completeness value” or “rate”) associated with one or more log files is defined as a ratio of log record counts (i.e., the number of log records actually received by the destination divided by the number of log records actually generated by the host). For example, consider a case in which a log file generated by a host contains 100,000 log records, while the corresponding log file received at the destination 160 (which ideally would contain the same number of records) contains only 92,000 records. The corresponding completeness value or rate associated with this scenario is then 0.92, or 92%. It should be noted that other expressions, representations, and/or definitions of log transfer completeness can be utilized in alternative embodiments if so desired. For instance, the number of “missing” log record counts can be used as simple log transfer completeness metric if so desired. Of course, other formulas, equations, or algorithms can be used to generate a suitable completeness metric.

In accordance with the exemplary embodiment described here, a host generates one log file each day for transfer to the destination 160. In an ideal scenario, each generated log file is transmitted to the destination 160 shortly after midnight (the end of each day), and such transmission is completed in only a few minutes. In practice, however, various factors may interrupt, delay, or otherwise inhibit quick and accurate transfer of log files. To this end, the system described here employs a particular methodology to measure completeness of the log files that arrive at the destination 160. More specifically, for each day, the quantity of logs at the destination 160 is measured at multiple delayed intervals to determine when (if ever) the threshold completeness value has been satisfied.

For example, for all logs produced on 1/15/2018, completeness is measured at the destination 160 at six-hour intervals: 1/16/2018 06:00 (6 hours delay); 1/16/2018 12:00 (12 hours delay); 1/16/2018 18:00 (18 hours delay); 1/17/2018 00:00 (24 hours delay); and so on. For each measurement time/interval, the destination 160 checks whether or not the designated completeness threshold is met. The completeness statistics and information can be displayed in a heatmap, a report, a chart, or the like.

By setting a completeness threshold, the system can ascertain the time delay after which the desired completeness is met. For example, it may take less than six hours for one daily log to be deemed “complete” at the destination 160, but it may take more than 48 hours for another daily log to be deemed “complete” at the destination 160. This technique helps in setting proper expectations with log consumers with respect to completeness latencies of the shipping pipeline.

As described in further detail below, systems and methods in accordance with various embodiments achieve a very high completeness value equal to or greater than a “target completeness value” by re-shipping (via network 150) or “replaying” a selected set of the log records (e.g., “replay candidates”) from their respective host or hosts. In the previous example, for instance, log file 122 may be considered a replay candidate whose replay (e.g., a retransfer requested by destination 160) would be expected to result in 8000 missing records being added to incomplete log file 162.

In accordance with an exemplary implementation, log completeness for an entire day is measured as an aggregate of all logs from all hosts. For a typical deployment, on any given day about 3,500 hosts produce logs with an average volume of 150 billion log records. That translates to more than 40 million log records per host. Assume that the desired completeness threshold is set to 99.999%. If only one host in a fleet of 3,500 hosts has trouble shipping logs, then the actual completeness value will be around 99.971%, which is below the desired threshold. Thus, when the full dataset is considered, the actual completeness does not satisfy the desired threshold. This information, however, does not provide context on how much of the fleet is impacted and the extent of the impact. For example, 99.971% completeness could mean: one host is not shipping any logs (40 million records missing); or 40 hosts did not ship one million logs each; or some other combination of missing records that totals 40 million.

In this regard, the system described here employs a novel computation method and introduces different “service levels” associated with the manner in which the completeness value is computed. Usually the log shipping pipeline is certified for a completeness rate for the data at the destination compared to the source, such as 99.9%, 99.99%, etc. In accordance with certain embodiments, the log shipping pipeline is certified at 99.999%. This value is the “desired completeness” threshold that must be satisfied.

To this end, the exemplary system defines and utilizes three completeness profiles or service levels—P99, P99.9 and P100. These profiles are akin to levels of service—Silver, Gold, Platinum. These are used for SLAs and contractual agreements with the clients of the log shipping service. The first category or service level (labeled P100 here) is associated with the computation of log completeness for the entire dataset, i.e., all hosts and all log files are considered. Customers or subscribers at the P100 level require the highest log file fidelity at the destination 160, and the P100 level provides the highest guarantee of completeness. As an example, if there are 1,000 hosts and the overall completeness for all 1,000 hosts is above the desired completeness threshold, then replays are not required. If, however, the overall completeness rate for the 1,000 hosts is below the desired completeness threshold, then at least one replay will be needed to meet the contractual needs of the P100 profile.

The second category or service level (labeled P99.9 here) is associated with the computation of log completeness for only 99.9% of the full dataset, after eliminating the “worst performing” 0.1% of hosts. Accordingly, customers or subscribers at the P99.9 level can accept slightly imperfect log file fidelity at the destination 160, and the P99.9 level provides a moderate guarantee of completeness. As an example, if there are 1,000 hosts and the completeness rate for the 999 best hosts (based on ranking) is above the desired completeness threshold, then replays are not required. If the completeness rate for the 999 hosts is below the desired completeness threshold, then at least one replay will be needed to meet the contractual needs of the P99.9 profile.

The third category or service level (arbitrarily labeled P99 here) is associated with the computation of log completeness for only 99% of the full dataset, after eliminating the “worst performing” 1.0% of hosts. Customers or subscribers at the P99 level tolerate a relatively high amount of log file infidelity at the destination 160, and the P99 level provides the loosest guarantee of completeness. As an example, if there are 1,000 hosts and the completeness rate for the 990 best hosts (based on ranking) is above the desired completeness threshold, then replays are not required. If the completeness rate for the 990 hosts is below the desired completeness threshold, then at least one replay will be needed to meet the contractual needs of the P99 profile.

In practice, the P100 service level corresponds to the highest completeness fidelity, the P99.9 service level corresponds to a relatively intermediate completeness fidelity, and the P99 service level corresponds to a relatively low completeness fidelity. This provides a perspective to customers that when P100 is below threshold, looking at P99.9 and P99 would indicate the spread of the impact. For example, after receiving the daily log files for Jan. 22, 2018, the destination 160 might determine that the stated completeness threshold is not met for the P100 category (i.e., when considering the full dataset), but that the completeness threshold is met for the P99.9 and P99 categories. For this scenario, it will be necessary to request retransmission of at least some log files to satisfy the P100 requirements. In contrast, retransmission of log files is not needed for P99.9 and P99 service level customers.

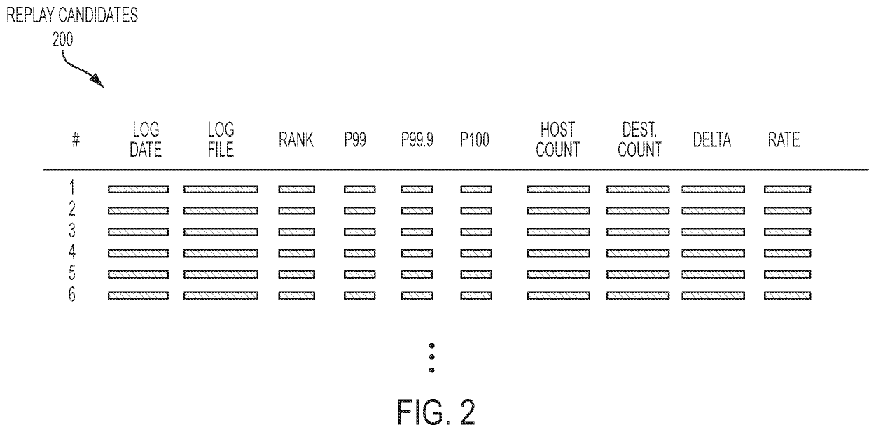

FIG. 2 depicts, in tabular form, the ranking of various log files (replay candidates) in accordance with one, non-limiting example. As a preliminary matter, the term “rank” or “ranking” does not necessarily require that a processor produce a visual representation of a ranking as shown in FIG. 2—though such a visual representation may be useful in providing to the user an indication of log record completeness (e.g., in connection with a host's “dashboard” or other user interface). For example, the “ranking” may be merely a logical ranking of replay candidates as performed by software and/or hardware, and need not even require that the replay candidates be stored in rank order within a memory device.

With continued reference to FIG. 2, the illustrated ranking 200 includes, in this case, six replay candidates numbered 1 through 6. While a variety of fields may be considered in determining the ranking, FIG. 2 illustrates ten such fields: log date (i.e., the date that the log file was created and/or transferred to its destination); log file name (i.e., an arbitrary unique identifier for the log file); rank (i.e., the ranking of the log file in accordance with the applicable ranking criteria); various fields indicating whether the respective log files should be replayed to satisfy the completeness threshold associated with different service levels (e.g., P99, P99.9, and P100 levels); the host count (i.e., the record count for that log file as it exists at the originating host); the destination count (i.e., the actual received record count for that log file as it exists at the destination); the delta (i.e., the difference between the host and destination record counts); and the “rate” or completeness value for that log file (as defined above).

In certain embodiments, the log files in FIG. 2 are ranked in order of completeness impact, with the “worst” replay candidates (for a particular time-frame, such as 24 hours) being listed toward the top of list 200. As used herein, the term “completeness” impact indicates the relative impact that a log file, if replayed, would have on increasing the completeness. For example, it might be the case that log file #1 in list 200 would increase the overall completeness of the accumulated log files by 2%, while log file #3 would increase the overall completeness of the accumulated log files by 1%.

The system described here can employ any suitable and appropriate scheme to rank the replay candidates. In accordance with certain exemplary embodiments, ranking of “offending” hosts is performed in the manner described here. It should be appreciated that alternative or additional ranking schemes, approaches, or algorithms can be leveraged if so desired. For this example, assume that there are 1,000 hosts (labeled H1 through H1000). Also assume that each host is associated with two log record counts: a first count at the source (labeled S1 through S1000); and a second count at the destination (labeled D1 through D1000). Ideally, the S count value will match the corresponding D count value. In reality, those count values usually do not match. Using this nomenclature, the Overall Completeness value is calculated as follows: Overall Completeness=sum(D1 to D1000)/sum(S1 to S1000).

For this example, the ranking methodology begins by eliminating one host from the set that includes H1 to H1000, e.g., eliminate the host H1. Next, compute the Overall Completeness value (C1) based on the remaining 999 hosts. Repeat these steps by eliminating one host from the set (for example, replace H1, eliminate H2, and compute C2; then replace H2, eliminate H3, and compute C3; and so on) until the values of C1 to C1000 are obtained. Next, sort the values of C1 to C1000 in descending/ascending order. After sorting, the worst offending host will appear at the top/bottom of the sorted list, wherein elimination of the worst offending host has the highest impact on the log completeness value.

Using the computed completeness impacts, all or a subset of the listed replay candidates may be replayed to accomplish a desired, targeted completeness level. In FIG. 2, for example, the fields that appear under the headings P99, P99.9, and P100 may be logical fields or flags indicating whether a replay of that particular log file is “mandatory,” “recommended,” or “unnecessary” for purposes of achieving the threshold completeness as calculated in accordance with the computational scheme utilized for the given service level (P99, P99.9, or P100). Thus, to satisfy the log file fidelity requirement of the P100 level, it is possible that all of the log files (numbers 1-6) would need to be replayed. In contrast, to satisfy the log file fidelity requirement of the P99 level, then perhaps only log files 1-3 would need to be replayed. In this regard, a subset of replay candidate log files is determined based on a selected one of the completeness levels.

If completeness is below the desired threshold, replay will be required. How much to replay, however, depends on which completeness profile (level of service) is applicable. The system described here can employ any suitable and appropriate methodology to determine the extent and amount of replay to request (in order to meet the desired completeness threshold).

The methodology utilized by certain exemplary embodiments is described in more detail below. However, it should be appreciated that alternative or additional schemes, approaches, or algorithms can be leveraged if so desired.

For this example, assume that there are 1,000 hosts, and that the desired log completeness is 99.999%. Also assume that the actual measured overall completeness rates for the three different profiles are: P99=99.999%; P99.9=99.99%; P100=99.9%. Accordingly, if the client has subscribed to the P99 service level and completeness profile, then no replay is required because the desired completeness is met. However, if the client has subscribed to the P99.9 or P100 service level, then replays will be needed because 99.999% completeness has not been achieved for either of those service levels. It is also evident that less replays would be required to meet the desired completeness for P99.9, and that more replays will be required to meet the desired completeness for P100.

Step 1: For this example, the methodology begins by considering the top ranked host (i.e., the worst offender as explained above) as the replay candidate.

Step 2: Replace the destination count (D) with the source count (S) for this host—this count substitution assumes that a successful replay will result in a matching count for this host.

Step 3: Apply the ranking scheme (described above) to the set of hosts, using the modified count value.

Step 4: If the calculated P99 completeness satisfies the desired completeness value, then go to Step 7.

Step 5: Eliminate the worst 1% based on the host rank, and compute the completeness for P99.

Step 6: Include this host as a replay candidate for P99.

Step 7: If the P99.9 completeness satisfies the desired completeness value, then go to Step 11.

Step 8: Eliminate the worst 0.1% based on the host rank, and compute the completeness for P99.9.

Step 9: Include this host as a replay candidate for P99.9.

Step 10: Repeat from Step 1 with the next ranked host.

Step 11: End

The above logic can be extended if the P99 completeness does not satisfy the desired completeness value.

In this example, the iteration begins with the top ranked host (or the worst offender), as it will have the best impact on completeness improvement. The next worst offender is considered next, and so on. At the end, this methodology will obtain the minimum replay candidates for all affected completeness profiles that are below the desired/stated completeness rate. Mathematically, the P100 profile will have the most replay candidates, and the P99 profile will have the least (recall that for this example the P99.9 profile does not require any replays).

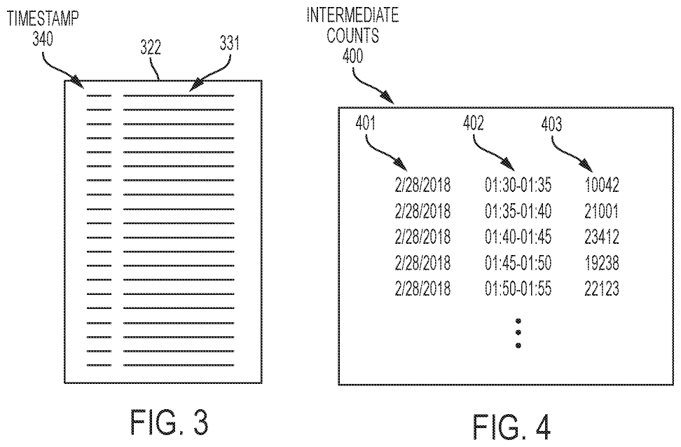

As mentioned above, due to the size of the log files (which may include millions of records) it would be time consuming to replay the entire file. In that regard, referring now to FIGS. 3 and 4, to prevent unnecessary replay of an entire log file (which may be very large), “intermediate counts” are determined for each log file (e.g., number of log records within a series of 5-minute intervals). In this way, the data loss can be narrowed down to particular “gaps” in the intermediate counts, and only the log records in the host log file corresponding to these gaps need be replayed. That is, as shown in FIG. 3, a given log file 322 may include a timestamp (with any convenient temporal granularity) 340 and associated log text 331.

An intermediate count file 400 may be generated (and stored on destination 160 and/or a host 110) by a processor based on an existing log file 322 such that it includes a date field 401 (e.g., the day that log file 322 was created), a time range field 402 (e.g., a five-minute or other interval), and a count field 403 (i.e., the number of log file records that occurred within that time range). Subsequently, a corresponding intermediate count file can be constructed for a log file within the destination and then compared to file 400 in FIG. 4. This allows only those log file records within the most affected time ranges to be replayed. For example, it may be determined that the 23412 records recorded on 2/28/2018 between the times of 01:40 and 01:45 are missing from the corresponding log file in destination 160. Those particular records can then be selected for replay to the extent they assist in reaching the target completeness value.

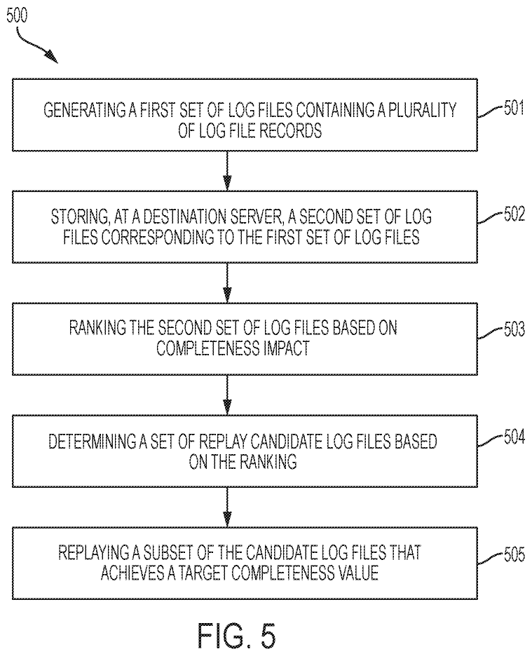

FIG. 5 is a block diagram illustrating a method 500 in accordance with an embodiment, and is described in conjunction with previously referenced FIGS. 1-4. The various tasks performed in connection with the method 500 may be performed by software, hardware, firmware, or any combination thereof. For illustrative purposes, the following description of the method 500 may refer to elements mentioned above in connection with FIGS. 1-4. In practice, portions of the method 500 may be performed by different elements of the described system. It should be appreciated that the method 500 may include any number of additional or alternative tasks, the tasks shown in FIG. 5 need not be performed in the illustrated order, and the method 500 may be incorporated into a more comprehensive procedure or process having additional functionality not described in detail herein. Moreover, one or more of the tasks shown in FIG. 5 could be omitted from an embodiment of the method 500 as long as the intended overall functionality remains intact.

Referring again to FIG. 1, in accordance with the illustrated embodiment of the system 100, the destination 160 includes a log file fidelity module 166. The log file fidelity module 166 may be realized with a processor device, software, hardware, processing logic, or the like. The log file fidelity module 166 is suitably configured to provide the functionality, intelligence, and logic that is necessary to perform the various log file fidelity operations described in detail herein. In alternative implementations, the functionality of the log file fidelity module 166 can be distributed among a plurality of hardware components, computing devices, servers, or the like. For example, some of the required functionality can reside at the destination 160, and some of the required functionality can reside at one or more of the hosts 100 if so desired.

Referring back to FIG. 5, initially, at 501, a first set of log files (e.g., 120) are generated by associated apps (e.g., 141-143) running within a given host (e.g., 111-113). It will be appreciated that these hosts 111-113 may each be associated with one or more “partners” that have access to or are otherwise associated with an organization and or a “subscriber” (e.g., an individual, partnership, corporation, etc.) associated with an organization. In this regard, as used herein, a “tenant” or an “organization” should be understood as referring to a group of one or more users, subscribers, developers, partners, or the like (typically employees) that share access to a host and/or a common subset of the data within a database. Each host 110 or enterprise tenant may be associated with a company, corporate department, business or legal organization, and/or any other entities that maintain data for sets of users (such as their respective employees or customers).

In accordance with the embodiment described here, the first set of log files is intended to be communicated from the originating host(s) 110 to the destination 160. This description assumes that the destination 160 (or the associated database system that implements the destination 160) receives at least some of the first set of log files. Thereafter, processing continues at 502, in which a second set of log files (e.g., 162) are stored within the destination 160, wherein the second set of log files “correspond” to their respective log files stored at the host(s). As mentioned above, the log files residing at the destination may or may not include the same number of log records stored at the host.

The first and second sets of log files are analyzed, reviewed, or compared as needed. In this regard, the record counts of the first set of log files can be compared against the record counts of the second set of log files, to determine if there is any discrepancy. Next, at 503, for a given time frame (e.g., 24 hours, 48 hours, or any other convenient time frame), the set of log files (at both hosts 110 and destination 160) are ranked in accordance with completeness impact, as described above. To this end, the ranking may be based on a difference in record counts between the first and second sets of log files.

Using the above ranking, at step 504 a set of replay candidates are determined based on the ranking, and then a subset of those replay candidates are replayed (at 505) to achieve a target completeness value (for the selected timeframe). For example, the target completeness value may be 99.9%, corresponding to the goal of compiling 99.9% of all log file records generated by hosts 110 during the selected timeframe. It will be appreciated that the target completeness value may be selected in accordance with a variety of factors, and need not be in the range of 99-100% as shown in the illustrated embodiment. In certain embodiments, the replay candidates are received from a plurality of host servers, and the system requests replays only from a selected number of those host servers, e.g., only the worst offending hosts.

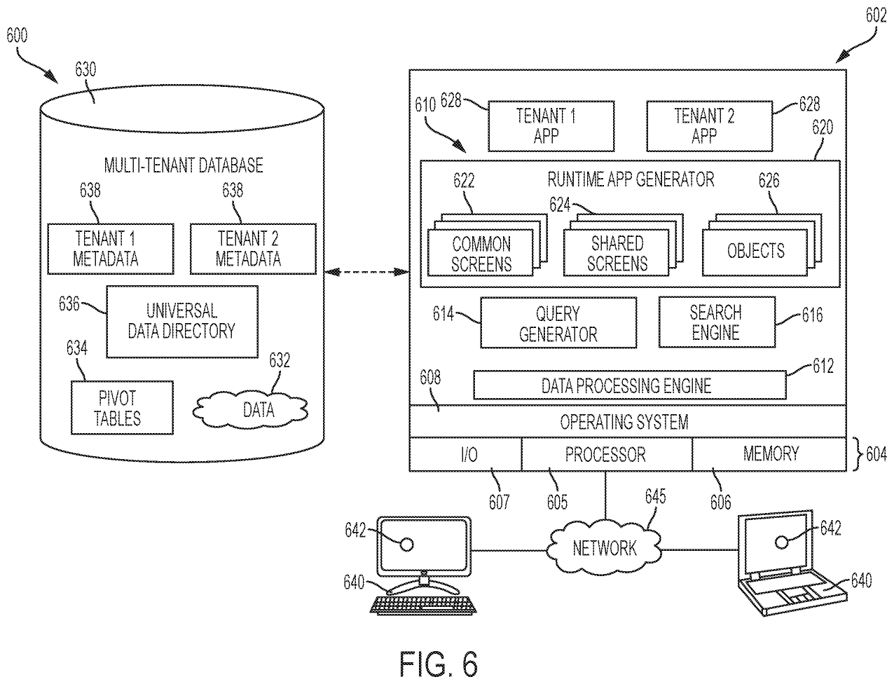

FIG. 6 depicts an exemplary embodiment of an on-demand multi-tenant database system 600 suitable for use with the system 100 of FIG. 1. The illustrated database system 600 of FIG. 6 includes a server 602 that dynamically creates and supports virtual applications 628 based upon data 632 from a common database 630 that is shared between multiple tenants, alternatively referred to herein as a multi-tenant database. Data and services generated by the virtual applications 628 are provided via a network 645 to any number of client devices 640, as desired. Each virtual application 628 is suitably generated at run-time (or on-demand) using a common application platform 610 that securely provides access to the data 632 in the database 630 for each of the various tenants subscribing to the database system 600. In accordance with one non-limiting example, the database system 600 is implemented in the form of an on-demand multi-tenant customer relationship management (CRM) system that can support any number of authenticated users of multiple tenants.

As used herein, a “tenant” or an “organization” should be understood as referring to a group of one or more users that shares access to common subset of the data within the multi-tenant database 630. In this regard, each tenant includes one or more users associated with, assigned to, or otherwise belonging to that respective tenant. To put it another way, each respective user within the database system 600 is associated with, assigned to, or otherwise belongs to a particular tenant of the plurality of tenants supported by the database system 600. Tenants may represent customers, customer departments, business or legal organizations, and/or any other entities that maintain data for particular sets of users within the database system 600 (i.e., in the multi-tenant database 630). For example, the application server 602 may be associated with one or more tenants supported by the database system 600. Although multiple tenants may share access to the server 602 and the database 630, the particular data and services provided from the server 602 to each tenant can be securely isolated from those provided to other tenants (e.g., by restricting other tenants from accessing a particular tenant's data using that tenant's unique organization identifier as a filtering criterion). The multi-tenant architecture therefore allows different sets of users to share functionality and hardware resources without necessarily sharing any of the data 632 belonging to or otherwise associated with other tenants.

The multi-tenant database 630 is any sort of repository or other data storage system capable of storing and managing the data 632 associated with any number of tenants. The database 630 may be implemented using any type of conventional database server hardware. In various embodiments, the database 630 shares processing hardware 604 with the server 602. In other embodiments, the database 630 is implemented using separate physical and/or virtual database server hardware that communicates with the server 602 to perform the various functions described herein. In an exemplary embodiment, the database 630 includes a database management system or other equivalent software capable of determining an optimal query plan for retrieving and providing a particular subset of the data 632 to an instance of virtual application 628 in response to a query initiated or otherwise provided by a virtual application 628. The multi-tenant database 630 may alternatively be referred to herein as an on-demand database, in that the multi-tenant database 630 provides (or is available to provide) data at run-time to on-demand virtual applications 628 generated by the application platform 610.

In practice, the data 632 may be organized and formatted in any manner to support the application platform 610. In various embodiments, the data 632 is suitably organized into a relatively small number of large data tables to maintain a semi-amorphous “heap”-type format. The data 632 can then be organized as needed for a particular virtual application 628. In various embodiments, conventional data relationships are established using any number of pivot tables 634 that establish indexing, uniqueness, relationships between entities, and/or other aspects of conventional database organization as desired. Further data manipulation and report formatting is generally performed at run-time using a variety of metadata constructs. Metadata within a universal data directory (UDD) 636, for example, can be used to describe any number of forms, reports, workflows, user access privileges, business logic and other constructs that are common to multiple tenants. Tenant-specific formatting, functions and other constructs may be maintained as tenant-specific metadata 638 for each tenant, as desired. Rather than forcing the data 632 into an inflexible global structure that is common to all tenants and applications, the database 630 is organized to be relatively amorphous, with the pivot tables 634 and the metadata 638 providing additional structure on an as-needed basis. To that end, the application platform 610 suitably uses the pivot tables 634 and/or the metadata 638 to generate “virtual” components of the virtual applications 628 to logically obtain, process, and present the relatively amorphous data 632 from the database 630.

Still referring to FIG. 5, the server 602 is implemented using one or more actual and/or virtual computing systems that collectively provide the dynamic application platform 610 for generating the virtual applications 628. For example, the server 602 may be implemented using a cluster of actual and/or virtual servers operating in conjunction with each other, typically in association with conventional network communications, cluster management, load balancing and other features as appropriate. The server 602 operates with any sort of conventional processing hardware 604, such as a processor 605, memory 606, input/output features 607 and the like. The input/output features 607 generally represent the interface(s) to networks (e.g., to the network 645, or any other local area, wide area or other network), mass storage, display devices, data entry devices and/or the like. The processor 605 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 606 represents any non-transitory short or long term storage or other computer-readable media capable of storing programming instructions for execution on the processor 605, including any sort of random access memory (RAM), read only memory (ROM), flash memory, magnetic or optical mass storage, and/or the like. The computer-executable programming instructions, when read and executed by the server 602 and/or processor 605, cause the server 602 and/or processor 605 to create, generate, or otherwise facilitate the application platform 610 and/or virtual applications 628 and perform one or more additional tasks, operations, functions, and/or processes described herein. It should be noted that the memory 606 represents one suitable implementation of such computer-readable media, and alternatively or additionally, the server 602 could receive and cooperate with external computer-readable media that is realized as a portable or mobile component or application platform, e.g., a portable hard drive, a USB flash drive, an optical disc, or the like.

The application platform 610 is any sort of software application or other data processing engine that generates the virtual applications 628 that provide data and/or services to the client devices 640. In a typical embodiment, the application platform 610 gains access to processing resources, communications interfaces and other features of the processing hardware 604 using any sort of conventional or proprietary operating system 608. The virtual applications 628 are typically generated at run-time in response to input received from the client devices 640. For the illustrated embodiment, the application platform 610 includes a bulk data processing engine 612, a query generator 614, a search engine 616 that provides text indexing and other search functionality, and a runtime application generator 620. Each of these features may be implemented as a separate process or other module, and many equivalent embodiments could include different and/or additional features, components or other modules as desired.

The runtime application generator 620 dynamically builds and executes the virtual applications 628 in response to specific requests received from the client devices 640. The virtual applications 628 are typically constructed in accordance with the tenant-specific metadata 638, which describes the particular tables, reports, interfaces and/or other features of the particular application 628. In various embodiments, each virtual application 628 generates dynamic web content that can be served to a browser or other client program 642 associated with its client device 640, as appropriate.

The runtime application generator 620 suitably interacts with the query generator 614 to efficiently obtain multi-tenant data 632 from the database 630 as needed in response to input queries initiated or otherwise provided by users of the client devices 640. In a typical embodiment, the query generator 614 considers the identity of the user requesting a particular function (along with the user's associated tenant), and then builds and executes queries to the database 630 using system-wide metadata 636, tenant specific metadata 638, pivot tables 634, and/or any other available resources. The query generator 614 in this example therefore maintains security of the common database 630 by ensuring that queries are consistent with access privileges granted to the user and/or tenant that initiated the request. In this manner, the query generator 614 suitably obtains requested subsets of data 632 accessible to a user and/or tenant from the database 630 as needed to populate the tables, reports or other features of the particular virtual application 628 for that user and/or tenant.

Still referring to FIG. 6, the data processing engine 612 performs bulk processing operations on the data 632 such as uploads or downloads, updates, online transaction processing, and/or the like. In many embodiments, less urgent bulk processing of the data 632 can be scheduled to occur as processing resources become available, thereby giving priority to more urgent data processing by the query generator 614, the search engine 616, the virtual applications 628, etc.

In exemplary embodiments, the application platform 610 is utilized to create and/or generate data-driven virtual applications 628 for the tenants that they support. Such virtual applications 628 may make use of interface features such as custom (or tenant-specific) screens 624, standard (or universal) screens 622 or the like. Any number of custom and/or standard objects 626 may also be available for integration into tenant-developed virtual applications 628. As used herein, “custom” should be understood as meaning that a respective object or application is tenant-specific (e.g., only available to users associated with a particular tenant in the multi-tenant system) or user-specific (e.g., only available to a particular subset of users within the multi-tenant system), whereas “standard” or “universal” applications or objects are available across multiple tenants in the multi-tenant system. For example, a virtual CRM application may utilize standard objects 626 such as “account” objects, “opportunity” objects, “contact” objects, or the like. The data 632 associated with each virtual application 628 is provided to the database 630, as appropriate, and stored until it is requested or is otherwise needed, along with the metadata 638 that describes the particular features (e.g., reports, tables, functions, objects, fields, formulas, code, etc.) of that particular virtual application 628. For example, a virtual application 628 may include a number of objects 626 accessible to a tenant, wherein for each object 626 accessible to the tenant, information pertaining to its object type along with values for various fields associated with that respective object type are maintained as metadata 638 in the database 630. In this regard, the object type defines the structure (e.g., the formatting, functions and other constructs) of each respective object 626 and the various fields associated therewith.

Still referring to FIG. 6, the data and services provided by the server 602 can be retrieved using any sort of personal computer, mobile telephone, tablet or other network-enabled client device 640 on the network 645. In an exemplary embodiment, the client device 640 includes a display device, such as a monitor, screen, or another conventional electronic display capable of graphically presenting data and/or information retrieved from the multi-tenant database 630. Typically, the user operates a conventional browser application or other client program 642 executed by the client device 640 to contact the server 602 via the network 645 using a networking protocol, such as the hypertext transport protocol (HTTP) or the like. The user typically authenticates his or her identity to the server 602 to obtain a session identifier (“SessionID”) that identifies the user in subsequent communications with the server 602. When the identified user requests access to a virtual application 628, the runtime application generator 620 suitably creates the application at run time based upon the metadata 638, as appropriate. As noted above, the virtual application 628 may contain Java, ActiveX, or other content that can be presented using conventional client software running on the client device 640; other embodiments may simply provide dynamic web or other content that can be presented and viewed by the user, as desired.

Referring again to FIG. 1, and with continued reference to FIG. 6, in certain exemplary embodiments, the server 602 and/or the application platform 610 supports the various log file fidelity checking operations described herein. In this regard, the exemplary system 100 shown in FIG. 1 can be implemented (partially or wholly) with one or more instantiations of the database system 600 depicted in FIG. 6. For example, the hosts 110 and the destination 160 can be realized with one piece of system hardware, or as a distributed platform with a plurality of hardware components that communicate with one another. These and other practical implementations are contemplated by this disclosure.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium, such as an electronic circuit, a semiconductor memory device, a ROM, a flash memory, an erasable ROM (EROM), a floppy diskette, a CD-ROM, an optical disk, a hard disk, or the like.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

1. A method of log file remediation, comprising:
receiving, at a database system, a first set of log files, each including a plurality of log file records;
storing, at the database system, a second set of log files, each substantially corresponding to a respective one of the first set of log files;
comparing, at the database system, record counts of the first set of log files with record counts of the second set of log files;
ranking, in response to the comparing, the second set of log files based on a completeness impact determined with respect to each of the second set of log files, the completeness impact computed based on a difference in record counts between the first and second sets of log files;
determining a set of replay candidate log files based on the ranking; and
requesting, by the database system, a replaying of a subset of the replay candidate log files that achieves a target completeness value.

2. The method of claim 1, wherein replaying the subset of replay candidate log files includes analyzing intermediate log record counts to determine gaps in the candidate log files.

3. The method of claim 1, further comprising:
generating the first set of log files at one or more host servers associated with the database system; and
communicating the first set of log files from the one or more host servers to the database system.

4. The method of claim 1, wherein the requesting comprises:
communicating a replay request from the database system to one or more host servers associated with the database system, wherein the one or more host servers respond to the replay request by providing the subset of the replay candidate log files.

5. A computer readable medium having computer-executable instructions stored thereon and configurable to be executed by a processor to perform a method comprising:
receiving, at a database system, a first set of log files, each including a plurality of log file records;
storing, at the database system, a second set of log files, each substantially corresponding to a respective one of the first set of log files;
comparing, at the database system, record counts of the first set of log files with record counts of the second set of log files;
ranking, in response to the comparing, the second set of log files based on a completeness impact determined with respect to each of the second set of log files, the completeness impact computed based on a difference in record counts between the first and second sets of log files;
determining a set of replay candidate log files based on the ranking; and
requesting, by the database system, a replaying of a subset of the replay candidate log files that achieves a target completeness value.

6. The computer readable medium of claim 5, wherein replaying the subset of replay candidate log files includes analyzing intermediate log record counts to determine gaps in the candidate log files.

7. The computer readable medium of claim 5, wherein the first set of log files is received from one or more host servers associated with the database system.

8. The computer readable medium of claim 5, wherein the requesting comprises:
communicating a replay request from the database system to one or more host servers associated with the database system, wherein the one or more host servers respond to the replay request by providing the subset of the replay candidate log files.

9. A database system comprising a processor in communication with a memory element having computer executable instructions stored thereon and configurable to be executed by the processor to cause the database system to:
receive a first set of log files, each including a plurality of log file records;
store a second set of log files, each substantially corresponding to a respective one of the first set of log files;
compare record counts of the first set of log files with record counts of the second set of log files;
rank, in response to comparing the record counts, the second set of log files based on a completeness impact determined with respect to each of the second set of log files, the completeness impact computed based on a difference in record counts between the first and second sets of log files;
determine a set of replay candidate log files based on ranking of the second set of log files; and
request a replaying of a subset of the replay candidate log files that achieves a target completeness value.

10. The database system of claim 9, wherein replaying the subset of replay candidate log files includes analyzing intermediate log record counts to determine gaps in the candidate log files.

11. The database system of claim 9, wherein the first set of log files is received from one or more host servers associated with the database system.

12. The database system of claim 9, wherein the requesting comprises:
communicating a replay request from the database system to one or more host servers associated with the database system, wherein the one or more host servers respond to the replay request by providing the subset of the replay candidate log files.

13. The method of claim 1, further comprising the step of defining a plurality of completeness levels associated with different log file completeness at the database system, wherein the subset of the replay candidate log files to be replayed is determined based on a selected one of the plurality of completeness levels.

14. The method of claim 1, wherein:
the first set of log files are received from a plurality of host servers; and
the replay candidate log files are replayed only from a selected number of the plurality of host servers.

15. The method of claim 1, wherein:
the first set of log files are received from a plurality of host servers; and
the ranking of the second set of log files results in a list of host servers ordered according to their impact on a log completeness value that is compared to the target completeness value.

16. The computer readable medium of claim 5, wherein the method performed by the processor further comprises the step of defining a plurality of completeness levels associated with different log file completeness at the database system, wherein the subset of the replay candidate log files to be replayed is determined based on a selected one of the plurality of completeness levels.

17. The computer readable medium of claim 5, wherein:
the first set of log files are received from a plurality of host servers; and
the replay candidate log files are replayed only from a selected number of the plurality of host servers.

18. The computer readable medium of claim 5, wherein:
the first set of log files are received from a plurality of host servers; and
the ranking of the second set of log files results in a list of host servers ordered according to their impact on a log completeness value that is compared to the target completeness value.

19. The database system of claim 9, wherein the computer executable instructions are configurable to be executed by the processor to cause the database system to define a plurality of completeness levels associated with different log file completeness at the database system, wherein the subset of the replay candidate log files to be replayed is determined based on a selected one of the plurality of completeness levels.

20. The database system of claim 9, wherein:
the first set of log files are received from a plurality of host servers;
the ranking of the second set of log files results in a list of host servers ordered according to their impact on a log completeness value that is compared to the target completeness value; and
the replay candidate log files are replayed only from a selected number of the plurality of host servers.
